(19) United States
(12) Patent Application Publication
(10) Pub. No.: US 2022/0403298 A1
(43) Pub. Date: Dec. 22, 2022

(54) ENZYMATIC EMULSIONS FOR DETERGENTS

(71) Applicant: Novozymes A/S, Bagsvaerd (DK)

(72) Inventors: Ole Simonsen, Soeborg (DK); Katarina Larson, Malmoe (SE); Kim Bruno Andersen, Vaerloese (DK); Cédric Hobel, Lyngby (FR)

(73) Assignee: Novozymes A/S, Bagsvaerd (DK)

(21) Appl. No.: 17/626,642

(22) PCT Filed: Jul. 10, 2020
(86) PCT No.: PCT/EP2020/069622

§ 371 Date: Jan. 12, 2022

(30) Foreign Application Priority Data
Jul. 12, 2019 (EP) 19186048.5

(51) Int. Cl. C11D 3/386; C11D 17/00; C11D 11/00

(52) U.S. Cl. CPC C11D 3/38618; C11D 3/38627; C11D 17/0017; C11D 11/0017; C11D 11/0023

(57) ABSTRACT

The invention provides an enzymatic water-in-oil emulsion, which is suitable for making multi-enzyme blends, and for producing enzymatic detergents.

### FIELD OF THE INVENTION

The present invention relates to enzymatic emulsions and blends thereof, which are suitable for use in liquid detergents.

### BACKGROUND

Enzymes are widely used as active ingredients in liquid detergents and are effective for general cleaning, stain removal, color care, etc. A wide range of enzymes are used today. Traditionally mainly protease and amylase were used, but today lipase, cellullase, mannanase, pectate lyase, and others, are increasingly used. In detergents, enzymes are typically used in low dosages, but are supplied from the enzyme manufacturer in concentrated form. Such concentrated liquid enzyme formulations are difficult to develop. The product is often stored and transported for long periods and may experience a range of temperatures. Thus, it is difficult to develop such concentrated enzyme formulations, that need to be enzymatically, physically and microbial stable for long periods at a wide range of temperatures. As the different enzymes behave differently, the optimal formulation, e.g., combination of polyols, salts and pH, varies from enzyme to enzyme. Some enzymes prefer, e.g., glycerol while others sorbitol. Some enzyme are most stable at low pH, others at higher pH, etc. Therefore enzymes are typically formulated as single enzyme formulations. Some enzymes are also mutually incompatible, for example, it can be difficult to make concentrated formulations containing both proteases and non-proteases, as the protease tend to degrade the other enzyme proteins. Blends of enzymes are rare as they require many compromises, and it may be impossible to find formulations that suits all ingoing enzymes. For the detergent manufacturer, it is complicated and expensive to have individual dosage systems for many different enzyme types (e.g., 5-7 different enzymes) and the logistics ordering and storing the enzymes are complex. There is thus a need from the detergent producers to have liquid enzyme blends.

We have found, that such blends are possible to produce by making a number of enzyme(water)-in-oil emulsions that can subsequently be blended.

Enzyme capsules are known in the art (e.g. WO99/01534, WO2014/177709). Such capsules are often produced via emulsions, but a membrane is created around the droplet. The capsules are designed to last in the liquid detergent (giving haze and problems with sedimentation) and release during wash. The intermediate emulsions, when making such capsules, only need to be stable for a short time until the surrounding wall is formed. Further, the oil can subsequently be (at least partly) removed.

U.S. Pat. No. 6,013,255 describe enzyme emulsions to be applied to feed, food and cosmetic products. Here the oil itself is a nutrient or an active in the end product, and relatively high oil levels are used. Further the emulsion does not need to break when applied to the end product.

### SUMMARY OF THE INVENTION

The present invention provides, in a first aspect, an enzymatic water-in-oil emulsion for use in the preparation of detergents, comprising

(a) at least 50% w/w of an aqueous phase comprising at least two detergent enzymes;
(b) an oil phase; and
(c) an emulsifier.

In embodiments, one part of the aqueous phase comprises a first detergent enzyme, and another part of the aqueous phase comprises a second detergent enzyme, and the first and second detergent enzymes are not present in the same part of the aqueous phase; or the aqueous phase comprises 0.1-30% w/w of active enzyme protein.

In a second aspect is provided a method for preparing an enzymatic detergent, comprising mixing the enzymatic water-in-oil emulsion of the invention with a detergent or a premix thereof.

Other aspects and embodiments of the invention are apparent from the description, examples and claims.

Unless otherwise indicated, or if it is apparent from the context that something else is meant, all percentages are percentage by weight (% w/w).

### DETAILED DESCRIPTION

We have found that enzyme blends for detergents can be produced by making a number of water(enzyme)-in-oil emulsions that are subsequently blended. Further, it is possible to load the aqueous phase of such emulsions with high amounts of enzyme that will retain excellent enzymatic activity during storage.

In such emulsions, the enzymes are located in individual droplets, and each droplet provides a micro environment optimized for the specific enzyme. When such emulsions are added to a liquid detergent, the emulsion breaks and a monotropic detergent is achieved. This is often preferred by detergent manufacturers to avoid haziness of the detergent and problems with sedimentation, if the detergent is multiphased.

A draw-back of using water(enzyme)-in-oil emulsions is that also the oil of the emulsion ends up in the liquid detergent and can reduce the effect of the detergent. It is therefore very important that the oil levels in such emulsions are kept low (see also Example 1). A high enzyme concentration in the emulsion also reduces the amount of emulsion needed to deliver the required amount of enzyme to a detergent.

The following properties influence the physical stability of emulsions:

“Coalescence” is the process by which two or more droplets merge during contact to form a single droplet. If severe coalescence occur the emulsion “breaks”, i.e., the system separates into bulk oil and water phases.

“Sedimentation” is the process by which the droplets sink to the bottom due to the droplets having a higher density than the continuous phase.

“Creaming” is the process by which the droplets migrate to the top due to the droplets having a lower density than the continuous phase.

“Flocculation” is the process where droplets tend to stick together (without merging) to form aggregates of multiple droplets.

Sedimentation, creaming and flocculation will typically lead to increased coalescence, and therefore also poor physical stability.

The emulsions of the invention maintain good physical stability during storage, and emulsions comprising two or more enzymes, which are prepared as single-enzyme emulsions and subsequently mixed to form a multi-enzyme emulsion, also retain excellent physical stability.

This is a huge advantage compared to preparation of multi-enzyme formulations made using traditional formulation chemistry, where each enzyme has individual formulation requirements. The emulsions of the invention can readily be mixed to form multi-enzyme emulsions, while retaining both physical and chemical stability.

The final concentrated enzyme product can be a mixture of emulsions, where the individual emulsions may contain:

(a) a single enzyme,
(b) a combination of compatible enzymes, or
(c) other active ingredient(s) than enzyme (if mixed with an enzyme containing emulsion).

Thus, a product could, for example, be a mixture of two or more emulsions, where each emulsion contains a single enzyme—or a mixture of one emulsion, where each droplet contain two different enzymes, mixed with an emulsion containing one single enzyme—or a mixture of one emulsion, where each droplet contain two different enzymes, mixed with an emulsion containing an active component other than enzymes, etc.

Further, the continuous oil phase can also contain actives. For example, many perfumes used in liquid detergent are oil soluble and could be added as an active to the continuous oil phase.

The addition of hydrophobic oils (or fats), like mineral oil or mono-, di- or tri-glycerides is generally unwanted in aqueous liquid detergents. Not being soluble in water, they tend to either separate out making the detergent physically unstable or, if the amount of oil is low, being emulsified into the aqueous liquid due to the content of surfactants present in the detergent. The latter will consume surfactant from the detergent, and the consumed surfactant will not be active on other hydrophobic soils during wash, and thus reduce the wash performance of the detergent. It is therefore of high importance to minimize the amount of oil phase carried by the enzyme emulsion, at least to a level where the detergent is physically stable, and preferably to a level where the wash performance is not significantly affected. As shown in Example 1, we have found that an emulsion containing less than 50% w/w of oil phase, will not significantly reduce detergency, when added in amounts needed to provide ordinary amounts of detergent enzyme(s).

As well-known in the art, the water-in-oil emulsion described can be further dispersed in an aqueous phase (using an oil-in-water emulsifier system) to make water-in-oil-in-water emulsions. This can be advantegous to the detergent manufacturer as, e.g., cleaning of water-wetted surfaces are easier than oil-wetted surfaces.

### Water-in-Oil Emulsion

Water-in-oil emulsions are hydrophilic/aqueous droplets dispersed in a continuous oil phase (in contrast to oil-in-water emulsion where oil droplets are dispersed in an aqueous continuum). Emulsions are typically prepared and stabilized using surface active components (molecules or particles) that have an affinity to the water/oil interface (emulsifiers).

The present invention provides an enzymatic water-in-oil emulsion for use in the preparation of detergents, comprising

(a) at least 50% w/w of an aqueous phase comprising at least two detergent enzymes;
(b) an oil phase; and
(c) an emulsifier.

In an embodiment, one part of the aqueous phase comprises a first detergent enzyme, and another part of the aqueous phase comprises a second detergent enzyme, and the first and second detergent enzymes are not present in the same part of the aqueous phase.

In another embodiment, the aqueous phase comprises 0.1-30% w/w of active enzyme protein.

The enzymatic water-in-oil emulsion of the invention is particularly useful in the preparation of detergents, as explained above, because the oil phase constitutes less than 50% of the emulsion.

The aqueous phase content of the emulsion is at least 50% w/w, preferably at least 55% w/w, and more preferably the aqueous phase content of the emulsion is at least 60% w/w.

Emulsifiers suitable for making emulsions of the invention are well-known in the art, and are described below.

When two different emulsions are mixed to provide a multi-enzyme emulsion, it may be advantageous to prepare the two emulsions with the same type of emulsifier. This will ensure compatibility of the two emulsions.

Emulsions may advantageously be prepared using emulsifiers that are not glycerol ester based, and oils that are not triglycerides, due to their sensitivity towards esterase activity (e.g., lipase) that may be present in the emulsion or the detergent.

### Aqueous Phase

The aqueous phase comprises at least one detergent enzyme. Further, the aqueous phase may include other compounds commonly used in the field of liquid enzyme formulation. This includes enzyme stabilizers, protease inhibitors, and other additives, as described below.

The aqueous phase may also include other water-soluble or water-dispersible actives for co-delivery with the enzyme.

The enzymes used in the emulsion of the invention are catalytic proteins, and the term “active enzyme protein” is defined herein as the amount of catalytic protein(s), which exhibits enzymatic activity. This can be determined using an activity based analytical enzyme assay. In such assays, the enzyme typically catalyzes a reaction generating a colored compound. The amount of the colored compound can be measured and correlated to the concentration of the active enzyme protein. This technique is well-known in the art.

The enzyme is a detergent enzyme, which may be selected from the group consisting of protease, lipase, cutinase, amylase, carbohydrase, cellulase, pectinase, mannanase, arabinase, galactanase, xanthanase, xylanase, nuclease (e.g., DNase, RNase), perhydrolase, and oxidase (e.g., laccase, peroxidase). In an embodiment, the enzyme is not a lipase.

Preferred detergent enzymes are selected from the group consisting of protease, lipase, amylase, cellulase, pectinase, mannanase, arabinase, galactanase, xylanase, nuclease (DNase, RNase), and perhydrolase. More preferred detergent enzymes are selected from the group consisiting of protease, amylase, cellulase, pectinase, mannanase, arabinase, galactanase, xylanase, nuclease (DNase, RNase), and perhydrolase.

The enzyme may be a naturally occurring enzyme of bacterial or fungal origin, or it may be a variant derived from one or more naturally occurring enzymes by gene shuffling and/or by substituting, deleting or inserting one or more amino acids. Chemically modified or protein engineered mutants are included.

The emulsion of the invention contains at least two detergent enzymes in an amount of 0.1-30% w/w active enzyme protein; preferably in an amount of 0.2-25% w/w active enzyme protein; more preferably in an amount of 0.5-20% w/w active enzyme protein, and most preferably in an amount of 1-20% w/w active enzyme protein.

### Cellulases

Suitable cellulases include mono-component and mixtures of enzymes of bacterial or fungal origin. Chemically modified or protein engineered mutants are also contemplated. The cellulase may for example be a mono-component or a mixture of mono-component endo-1,4-beta-glucanase also referred to as endoglucanase.

Suitable cellulases include those from the genera Bacillus, Pseudomonas, Humicola, Myceliophthora, Fusarium, Thielavia, Trichoderma, and Acremonium. Exemplary cellulases include a fungal cellulase from Humicola insolens (U.S. Pat. No. 4,435,307) or from Trichoderma, e.g. T. reesei or T. viride. Other suitable cellulases are from Thielavia e.g. Thielavia terrestris as described in WO 96/29397 or the fungal cellulases produced from Myceliophthora thermophila and Fusarium oxysporum disclosed in U.S. Pat. Nos. 5,648,263, 5,691,178, 5,776,757, WO 89/09259 and WO 91/17244. Also relevant are cellulases from Bacillus as described in WO 02/099091 and JP 2000210081. Suitable cellulases are alkaline or neutral cellulases having care benefits. Examples of cellulases are described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307.

Other cellulases are endo-beta-1,4-glucanase enzyme having a sequence of at least 97% identity to the amino acid sequence of position 1 to position 773 of SEQ ID NO:2 of WO 2002/099091 or a family 44 xyloglucanase, which a xyloglucanase enzyme having a sequence of at least 60% identity to positions 40-559 of SEQ ID NO: 2 of WO 2001/062903.

Commercially available cellulases include Carezyme®, Carezyme® Premium, Celluzyme®, Celluclean®, Celluclast®, Endolase®, Renozyme®; Whitezyme® Celluclean® Classic, Cellusoft® (Novozymes A/S), Puradax®, Puradax HA, and Puradax EG (available from Genencor International Inc.) and KAC-500(B)™ (Kao Corporation).

### Mannanases

Suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S).

### Proteases

Suitable proteases may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g. from the M4 family, or another metalloprotease such as those from the M5, M7 or M8 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a covalent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus. Examples of Bacillus species from which subtilases have been derived include Bacillus lentus, Bacillus alkalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN', subtilisin 309, subtilisin 147 and subtilisin 168 and e.g. protease PD138 (described in WO 93/18140). Other useful proteases are e.g. those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g. the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234. Preferred protease variants may, for example, comprise one or more of the mutations selected from the group consisting of: S3T, V41, S9R, S9E, A15T, S24G, S24R, K27R, N42R, S55P, G59E, G59D, N60D, N60E, V66A,

N74D, S85R, A96S, S97G, S97D, S97A, S97SD, S99E, S99D, S99G, S99M, S99N, S99R, S99H, S101A, V102I, V102Y, V102N, S104A, G116V, G116R, H118D, H118N, A120S, S126L, P127Q, S128A, S154D, A156E, G157D, G157P, S158E, Y161A, R164S, Q176E, N179E, S182E, Q185N, A188P, G189E, V193M, N198D, V199I, Q200L, Y203W, S206G, L211Q, L211D, N212D, N212S, M216S, A226V, K229L, Q230H, Q239R, N246K, S253D, N255W,

N255D, N255E, L256E, L256D T268A and R269H, wherein position numbers correspond to positions of the Bacillus lentus protease shown in SEQ ID NO: 1 of WO 2016/001449. Protease variants having one or more of these mutations are preferably variants of the Bacillus lentus protease (Savinase®, also known as subtilisin 309) shown in SEQ ID NO: 1 of WO 2016/001449 or of the Bacillus amyloliquefaciens protease (BPN') shown in SEQ ID NO: 2 of WO 2016/001449. Such protease variants preferably have at least 80% sequence identity to SEQ ID NO: 1 or to SEQ ID NO: 2 of WO 2016/001449.

Another protease of interest is the alkaline protease from Bacillus lentus DSM 5483, as described for example in WO 91/02792, and variants thereof which are described for example in WO 92/21760, WO 95/23221, EP 1921147, EP 1921148 and WO 2016/096711.

The protease may alternatively be a variant of the TY145 protease having SEQ ID NO: 1 of WO 2004/067737, for example a variant comprising a substitution at one or more positions corresponding to positions 27, 109, 111, 171, 173, 174, 175, 180, 182, 184, 198, 199 and 297 of SEQ ID NO: 1 of WO 2004/067737, wherein said protease variant has a sequence identity of at least 75% but less than 100% to SEQ ID NO: 1 of WO 2004/067737. TY145 variants of interest are described in e.g. WO 2015/014790, WO 2015/014803, WO 2015/014804, WO 2016/097350, WO 2016/097352, WO 2016/097357 and WO 2016/097354. Examples of preferred proteases include:

(a) variants of SEQ ID NO: 1 of WO 2016/001449 comprising two or more substitutions selected from the group consisting of S9E, N43R, N76D, Q206L, Y209W, S259D and L262E, for example a variant with the substitutions S9E, N43R, N76D, V205I, Q206L, Y209W, S259D, N261W and L262E, or with the substitutions S9E, N43R, N76D, N185E, S188E, Q191N, A194P, Q206L, Y209W, S259D and L262E, wherein position numbers are based on the numbering of SEQ ID NO: 2 of WO 2016/001449;
(b) a variant of the polypeptide of SEQ ID NO: 1 of WO 2016/001449 with the mutation S99SE, wherein position numbers are based on the numbering of SEQ ID NO: 2 of WO 2016/001449;
(c) a variant of the polypeptide of SEQ ID NO: 1 of WO 2016/001449 with the mutation S99AD, wherein position numbers are based on the numbering of SEQ ID NO: 2 of WO 2016/001449;
(d) a variant of the polypeptide of SEQ ID NO: 1 of WO 2016/001449 with the substitutions Y167A+R170S+A194P, wherein position numbers are based on the numbering of SEQ ID NO: 2 of WO 2016/001449;

(e) a variant of the polypeptide of SEQ ID NO: 1 of WO 2016/001449 with the substitutions S9R+A15T+V68A+N218D+Q245R, wherein position numbers are based on the numbering of SEQ ID NO: 2 of WO 2016/001449;

(f) a variant of the polypeptide of SEQ ID NO: 1 of WO 2016/001449 with the substitutions S9R+A15T+G61E+V68A+A194P+V205I+Q245R+N261D, wherein position numbers are based on the numbering of SEQ ID NO: 2 of WO 2016/001449;
(g) a variant of the polypeptide of SEQ ID NO: 1 of WO 2016/001449 with the substitutions S99D+S101R/E+S103A+V104I+G160S; for example a variant of SEQ ID NO: 1 of WO 2016/001449 with the substitutions S3T+V4I+S99D+S101E+S103A+V104I+G160S+V205I, wherein position numbers are based on the numbering of SEQ ID NO: 2 of WO 2016/001449;
(h) a variant of the polypeptide of SEQ ID NO: 2 of WO 2016/001449 with the substitutions S24G+S53G+S78N+S101N+G128A/S+Y217Q, wherein position numbers are based on the numbering of SEQ ID NO: 2 of WO 2016/001449;
(i) the polypeptide disclosed in GENESEQP under accession number BER84782, corresponding to SEQ ID NO: 302 in WO 2017/210295;
(j) a variant of the polypeptide of SEQ ID NO: 1 of WO 2016/001449 with the substitutions S99D+S101E+S103A+V104I+S156D+G160S+L262E, wherein position numbers are based on the numbering of SEQ ID NO: 2 of WO 2016/001449;
(k) a variant of the polypeptide of SEQ ID NO: 1 of WO 2016/001449 with the substitutions S9R+A15T+G61E+V68A+N76D+S99G+N218D+Q245R, wherein position numbers are based on the numbering of SEQ ID NO: 2 of WO 2016/001449;
(I) a variant of the polypeptide of SEQ ID NO: 1 of WO 2016/001449 with the substitutions V68A+S106A, wherein position numbers are based on the numbering of SEQ ID NO: 2 of WO 2016/001449; and
(m) a variant of the polypeptide of SEQ ID NO: 1 of WO 2004/067737 with the substitutions S27K+N109K+S111E+S171E+S173P+G174K+S175P+F180Y+G182A+L184F+Q198E+N199+T297P, wherein position numbers are based on the numbering of SEQ ID NO: 1 of WO 2004/067737.

Suitable commercially available protease enzymes include those sold under the trade names Alcalase®, Duralase™, Durazym™, Relase®, Relase® Ultra, Savinase®, Savinase® Ultra, Primase™, Polarzyme®, Kannase®, Liquanase®, Liquanase® Ultra, Ovozyme®, Coronase®, Coronase® Ultra, Blaze®, Blaze Evity® 100T, Blaze Evity® 125T, Blaze Evity® 150T, Blaze Evity® 200T, Neutrase®, Everlase®, Esperase®, Progress® Uno, Progress® In and Progress® Excel (Novozymes A/S), those sold under the tradename Maxatase™ Maxacal™, Maxapem®, Purafect® Ox, Purafect® OxP, Puramax®, FN2™, FN3™, FN4^{ex}™, Excellase®, Excellenz™ P1000, Excellenz™ P1250, Eraser™, Preferenz® P100, Purafect Prime, Preferenz P110™, Effectenz P1000™, Purafect®, Effectenz P1050™, Purafect® Ox, Effectenz™ P2000, Purafast™, Properase®, Opticlean™ and Optimase® (Danisco/DuPont), BLAP (sequence shown in FIG. 29 of U.S. Pat. No. 5,352,604) and variants hereof (Henkel AG), and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (US5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include Lipolase™, Lipex™, Lipolex™ and Lipoclean™ (Novozymes A/S), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

### Amylases

Suitable amylases may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, I201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

### M197T;

### H156Y+A181T+N190F+A209V+Q264S; or

### G48A+T49I+G107A+H156Y+A181T+N190F+I201F+A209V+Q264S.

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, I206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/023873 for numbering. More preferred variants are those having a deletion in two positions selected from 181, 182, 183 and 184, such as 181 and 182, 182 and 183, or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID

NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:

### N128C+K178L+T182G+Y305R+G475K;

### N128C+K178L+T182G+F202Y+Y305R+D319T+G475K;

S125A+N128C+K178L+T182G+Y305R+G475K; or S125A+N128C+T131I+T165I+K178L+T182G+Y305R+G475K wherein the variants are C-terminally truncated and optionally further comprises a substitution at position 243 and/or a deletion at position 180 and/or position 181.

Further suitable amylases are amylases having SEQ ID NO: 1 of WO13184577 or variants having 90% sequence identity to SEQ ID NO: 1 thereof. Preferred variants of SEQ ID NO: 1 are those having a substitution, a deletion or an insertion in one of more of the following positions: K176, R178, G179, T180, G181, E187, N192, M199, I203, S241, R458, T459, D460, G476 and G477. More preferred variants of SEQ ID NO: 1 are those having the substitution in one of more of the following positions: K176L, E187P, N192FYH, M199L, I203YF, S241QADN, R458N, T459S, D460T, G476K and G477K and/or deletion in position R178 and/or S179 or of T180 and/or G181. Most preferred amylase variants of SEQ ID NO: 1 are those having the substitutions:

### E187P+I203Y+G476K

### E187P+I203Y+R458N+T459S+D460T+G476K

wherein the variants optionally further comprises a substitution at position 241 and/or a deletion at position 178 and/or position 179.

Further suitable amylases are amylases having SEQ ID NO: 1 of WO10104675 or variants having 90% sequence identity to SEQ ID NO: 1 thereof. Preferred variants of SEQ ID NO: 1 are those having a substitution, a deletion or an insertion in one of more of the following positions: N21, D97, V128 K177, R179, S180, I181, G182, M200, L204, E242, G477 and G478.

More preferred variants of SEQ ID NO: 1 are those having the substitution in one of more of the following positions: N21D, D97N, V128I K177L, M200L, L204YF, E242QA, G477K and G478K and/or deletion in position R179 and/or S180 or of I181 and/or G182. Most preferred amylase variants of SEQ ID NO: 1 are those having the substitutions: N21D+D97N+V128I

wherein the variants optionally further comprises a substitution at position 200 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Fungamyl™, Stainzyme™, Stainzyme Plus™, Natalase™, Liquozyme X and BAN™ (from Novozymes A/S), and Rapidase™ , Purastar™/Effectenz™, Powerase, Preferenz S1000, Preferenz S100 and Preferenz S110 (from Genencor International Inc./DuPont).

Peroxidases/Oxidases

A suitable peroxidase is preferably a peroxidase enzyme comprised by the enzyme classification EC 1.11.1.7, as set out by the Nomenclature Committee of the International Union of Biochemistry and Molecular Biology (IUBMB), or any fragment derived therefrom, exhibiting peroxidase activity.

Suitable peroxidases include those of plant, bacterial or fungal origin. Chemically modified or protein engineered mutants are included. Examples of useful peroxidases include peroxidases from Coprinopsis, e.g., from C. cinerea (EP 179,486), and variants thereof as those described in WO 93/24618, WO 95/10602, and WO 98/15257.

Suitable peroxidases also include a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions. The haloperoxidase may be a chloroperoxidase. Preferably, the haloperoxidase is a vanadium haloperoxidase, i.e., a vanadate-containing haloperoxidase. In a preferred method the vanadate-containing haloperoxidase is combined with a source of chloride ion.

Suitable oxidases include, in particular, any laccase enzyme comprised by the enzyme classification EC 1.10.3.2, or any fragment derived therefrom exhibiting laccase activity, or a compound exhibiting a similar activity, such as a catechol oxidase (EC 1.10.3.1), an o-aminophenol oxidase (EC 1.10.3.4), ora bilirubin oxidase (EC 1.3.3.5).

### Nucleases

Suitable nucleases include deoxyribonucleases (DNases) and ribonucleases (RNases) which are any enzyme that catalyzes the hydrolytic cleavage of phosphodiester linkages in the DNA or RNA backbone respectively, thus degrading DNA and RNA. There are two primary classifications based on the locus of activity. Exonucleases digest nucleic acids from the ends. Endonucleases act on regions in the middle of target molecules. The nuclease is preferably a DNase, which is preferable is obtainable from a microorganism, preferably a bacterium; in particular a DNase which is obtainable from a species of Bacillus is preferred; in particular a DNase which is obtainable from Bacillus cibi, Bacillus subtilis or Bacillus licheniformis is preferred. Examples of such DNases are described in WO 2011/098579, WO2014/087011 and WO2017/060475.

Enzyme stabilizers

Many well-known stabilizers can be used in the aqueous phase, such as polyols, sugars, sugar alcohols, divalent cations, salts to increase the ionic strength, and protease inhibitors.

A polyol (or polyhydric alcohol) is an alcohol with two or more hydroxyl groups.

Examples of suitable polyols include, but are not limited to, glycerol, ethylene glycol, diethylene glycol, triethylene glycol, propylene glycol, dipropylene glycol, tripropylene glycol, polyethylene glycol (PEG), and polypropylene glycol (PPG).

Examples of sugars include, but are not limited to, glucose, sucrose, trehalose, and dextrins.

Examples of sugar alcohols include, but are not limited to, sorbitol, mannitol, erythritol, dulcitol, inositol, xylitol and adonitol.

Examples of divalent cations include, but are not limited to, calcium ions and magnesium ions.

Small organic acids, such as citric acid, acetic acid, formic acid, and their corresponding salts, may be used to adjust pH and stabilize the enzyme(s).

The pH of the aqueous enzymatic phase of the emulsion is typically in the range of pH 3-10, preferably in the range of 4-9.5, more preferably in the range of 4.5-9, even more preferably in the range of pH 5-9, and most preferably in the range of pH 5-8.5.

### Protease Stabilizers/Inhibitors

Proteases, as described above, may be stabilized using compounds that act by temporarily reducing the proteolytic activity (reversible inhibitors).

Thus, the composition of the invention may also include a protease inhibitor/stabilizer, which is a reversible inhibitor of protease activity, e.g., serine protease activity. Preferably, the protease inhibitor is a (reversible) subtilisin protease inhibitor. In particular, the protease inhibitor may be a peptide aldehyde, boric acid, or a boronic acid; or a derivative of any of these. Examples of protease inhibitors are shown in, for example, WO 96/041859, WO 2009/118375, WO 2010/055052, and WO 2013/004636.

Antioxidants or reducing agents like sulfite, thiosulfate, nitrite, ascorbic acid/ascorbate etc. are also frequently used to stabilize enzymes (and the water phase in general).

The stability of a water-in-oil emulsion can often be improved by addition of salts to the water phase. Salts with divalent cations like MgCl₂, MgSO₄, ZnCl₂, ZnSO₄, etc., are very efficient but any salts like NaCl, Na₂SO₄, KCl, K₂SO₄, etc., can be used.

The aqueous phase may further contain water soluble or dispersible component as known in the art, e.g., colors/dyes, other hydrophilic actives than ezymes like water soluble or dispersible polymers, buffers etc. Preservatives like benzoates, sorbates, phenoxyethanol, parabens, BIT, etc., may also be added.
Rheology Modifying Additives

Rheology modifiers are additives that changes the rheology of the phase. They are typically used to either thicken og thinning the viscosity, and/or to make shear thinning or thixotropic behavior. Addition of rheology modifiers can significantly improve the physical stability of emulsions. Many types of rheology modifiers are known in the art, both soluble and particulate types.

### Oil Phase

The oil phase may also include other oil-soluble or oil-dispersible actives for co-delivery with the enzyme. For example, many perfumes are oil-soluble and could advantageously be included in the oil-phase of the emulsion.

### Oil

The oil used to prepare the enzymatic water-in-oil emulsion is a hydrophobic liquid, substantially insoluble in water, at room temperature.

Different kinds of (carrier) oils can be used, e.g., organic (vegetable) oils, hydrocarbon (mineral, paraffinic) oils, silicone oils, etc.

Triglyceride oils may have reduced compatibility with lipases and are preferably not used in lipase containing emulsions or detergents.

Any oil (or liquid that is practically insoluble in water) can in principle be used for making water-in-oil emulsions. Oils are often divided into natural and synthetic oils. Synthetic oils can be hydrocarbons like mineral oils, e.g., paraffinic oils or silicone oils. Natural oils can be vegetable oils like fatty acids and mono- di- or triglycerides, but also other kinds of plant oils like fatty alcohol derived oil like esters or ethers, e.g. PPG stearyl ethers, dicaprylyl carbonate and many others are frequently used in the art. It is preferred to use oils which are liquid at room temperature, but higher melting types (fats/waxes) can also be used if emulsified at temperatures where they are molten.

The oil phase may contain oil soluble or dispersible components as known in the art, e.g., colors/dyes, actives like perfumes, hydrophobic polymers, antifoaming agents, etc.

The oil phase may further contain preservation agents and antioxidants like BHA, BHT, propyl gallate, TBHQ, tocepherols, carotene, etc.
Rheology modifying additives

Rheology modifiers are additives that changes the rheology of the phase. They are typically used to either thicken og thinning the viscosity, and/or to make shear thinning or thixotropic behavior. Addition of rheology modifiers can significantly improve the physical stability of emulsions. Many types of rheology modifiers are known in the art, both soluble and particulate types.

### Emulsifiers

A variety of emulsifiers are known in the art. An emulsifier (also known as an “emulgent”) is a substance that stabilizes an emulsion by increasing its kinetic stability. One class of emulsifiers is known as “surface active agents”, or surfactants. Emulsifiers are compounds that typically have a polar or hydrophilic (i.e., water-soluble) part and a non-polar (i.e., hydrophobic or lipophilic) part. Because of this, emulsifiers tend to have more or less solubility either in water or in oil. Emulsifiers that are more soluble in water (and conversely, less soluble in oil) will generally form oil-in-water emulsions, while emulsifiers that are more soluble in oil will form water-in-oil emulsions. Wilder Dwight Bancroft stated in 1910 that “The phase in which an emulsifier is more soluble constitutes the continuous phase.” (Bancroft's rule). This is a general rule that most often is correct.

Emulsifiers can be divided into low molecular weight emulsifiers and polymeric emulsifiers, either block polymers with one more more hydrophilic and hydrophobic blocks or random polymers with distributed hydrophilic and hydrophobic areas. Another class of emulsifiers is particles that absorb to the interphase between and can form so-called Pickering emulsions.

Examples of emulsifiers (including emulsion stabilizers) that are most used for water-in-oil or oil-in-water emulsions are alkoxylated alcohols such as Marlipal 24/70 (Sasol) or Berol 050 (Nouryon), glyceryl esters or derivatives thereof such as ISOLAN® GPS (Evonik) or Plurol® Diisostearique CG (Gattefossé), alkyl ether sulfates (the most commonly used is sodium laureth sulfate) such as Sulfochem™ ES-2BZ (Lubrizol), esters such as Cithrol™ DPHS (Croda), sorbitan derivatives such as Span ™ 20 or Tween™ 80 (Croda), non-glycerol ester based siloxanes and silanes such as ABIL® EM90 or ABIL® EM180 (Evonik), or mixtures of the above cited such as ISOLAN® 17 MB or ABIL® EM97 S (Evonik). Amphoteric polymeric emulsifiers as described in WO 97/24177, page 19-21; and in WO 99/01534. Well known particles used for obtaining and stabilizing Pickering emulsions are BENTONE® 34 (Elementis) or AEROSIL® R 972 (Evonik), but many others are known in the art.

Combinations of emulsifiers, or emulsifiers and emulsion stabilizers can be used. This can e.g. be combinations of smaller and larger molecules, or even soluble and particulate (Pickering type) emulsifiers. In some cases, one emulsifier if predominantly responsible for obtaining the right droplet size (e.g., a monomeric type emulsifier), while another emulsifier (or emulsion stabilizer, e.g. polymeric emulsifier or stabilizer) predominantly ensures that coalescence is minimized. In other cases combination of emulsifiers (and surfactants) can be used to optimize viscosity of the final emulsion. In some cases combination of predominantly oil-soluble and predominantly water-soluble emulsifiers are used.

In an embodiment, the emulsifier is not a glycerol ester.

### Processes

The emulsions of the invention can be prepared by high-speed mixing or stirring of the aqueous phase, the oil phase and the emulsifier. In this way, stable emulsions are obtained, which can be stably stored in this form.

Many other processes for making emulsions are known in the art, such as, dynamic or static mixers, high shear mixers/disperser/homogenizer, membrane emulsification, microfluidizers, ultrasound (acoustic) emulsification, high pressure homogenizers, colloidal mills, and self-emulsification. The process can be run in batch or continuous, as “one pass”, “multipass” or using “recirculation”. Often in two or more steps (often using different equipment/technologies in the steps) — first a “rough” emulsion is produced, then finer droplets are created in subsequent steps.

The emulsifier(s) is often mixed with the oil phase prior to preparation of the emulsion.

### Detergents

In one embodiment, the invention is directed to detergent compositions made using an enzyme emulsion of the present invention in combination with one or more additional cleaning composition components. The choice of additional components is within the skill of the artisan and includes conventional ingredients, including the exemplary non-limiting components set forth below.

When the enzyme emulsion is blended into the detergent composition, or a premix thereof, the emulsion will break (as described above), and the enzyme containing aqueous phase will be released and mixed with the detergent components, as if an enzyme solution was added directly to the detergent. Thus, the enzyme emulsion does not exist in the final detergent composition.

The choice of additional detergent components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

In one embodiment, the invention is directed to an ADW (Automatic Dish Wash) compositions comprising an enzyme of the present invention in combination with one or more additional ADW composition components. The choice of additional components is within the skill of the artisan and includes conventional ingredients, including the exemplary non-limiting components set forth below.

### Surfactants

The cleaning composition may comprise one or more surfactants, which may be anionic and/or cationic and/or non-ionic and/or semi-polar and/or zwitterionic, or a mixture thereof. In a particular embodiment, the detergent composition includes a surfactant system (comprising more than one surfactant) e.g. a mixture of one or more nonionic surfactants and one or more anionic surfactants. In one embodiment the detergent comprises at least one anionic surfactant than at least one non-ionic surfactant, the weight ratio of anionic to nonionic surfactant may be from 10:1 to 1:10. In one embodiment the amount of anionic surfactant is higher than the amount of non-ionic surfactant e.g. the weight ratio of anionic to non-ionic surfactant may be from 10:1 to 1.1:1 or from 5:1 to 1.5:1. The amount of anionic to non-ionic surfactant may also be equal and the weight ratios 1:1. In one embodiment the amount of non-ionic surfactant is higher than the amount of anionic surfactant and the weight ratio may be 1:10 to 1:1.1. Preferably the weight ratio of anionic to non-ionic surfactant is from 10:1 to 1:10, such as from 5:1 to 1:5, or from 5:1 to 1:1.2. Preferably, the weight fraction of non-ionic surfactant to anionic surfactant is from 0 to 0.5 or 0 to 0.2 thus non-ionic surfactant can be present or absent if the weight fraction is 0, but if non-ionic surfactant is present, then the weight fraction of the nonionic surfactant is preferably at most 50% or at most 20% of the total weight of anionic surfactant and non-ionic surfactant. Light duty detergent usually comprises more nonionic than anionic surfactant and there the fraction of non-ionic surfactant to anionic surfactant is preferably from 0.5 to 0.9. The total weight of surfactant(s) is typically present at a level of from about 0.1% to about 60% by weight, such as about 1% to about 40%, or about 3% to about 20%, or about 3% to about 10%. The surfactant(s) is chosen based on the desired cleaning application, and may include any conventional surfactant(s) known in the art. When included therein the detergent will usually contain from about 1% to about 40% by weight of an anionic surfactant, such as from about 5% to about 30%, including from about 5% to about 15%, or from about 15% to about 20%, or from about 20% to about 25% of an anionic surfactant. Non-limiting examples of anionic surfactants include sulfates and sulfonates, typically available as sodium or potassium salts or salts of monoethanolamine (MEA, 2-aminoethan-1-ol) or triethanolamine (TEA, 2,2′,2″-nitrilotriethan-1-ol); in particular, linear alkylbenzenesulfonates (LAS), isomers of LAS such as branched alkylbenzenesulfonates (BABS) and phenylalkanesulfonates; olefin sulfonates, in particular alpha-olefinsulfonates (AOS); alkyl sulfates (AS), in particular fatty alcohol sulfates (FAS), i.e., primary alcohol sulfates (PAS) such as dodecyl sulfate; alcohol ethersulfates (AES or AEOS or FES, also known as alcohol ethoxysulfates or fatty alcohol ether sulfates); paraffin sulfonates (PS) including alkane-1-sulfonates and secondary alkanesulfonates (SAS); ester sulfonates, including sulfonated fatty acid glycerol esters and alpha-sulfo fatty acid methyl esters (alpha-SFMe or SES or MES); alkyl- or alkenylsuccinic acids such as dodecenyl/tetradecenyl succinic acid (DTSA); diesters and monoesters of sulfosuccinic acid; fatty acid derivatives of amino acids. Furthermore, salts of fatty acids (soaps) may be included. When included therein the detergent will usually contain from about 1% to about 40% by weight of a cationic surfactant, for example from about 0.5% to about 30%, in particular from about 1% to about 20%, from about 3% to about 10%, such as from about 3% to about 5%, from about 8% to about 12% or from about 10% to about 12%. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein the detergent will usually contain from about 0.2% to about 40% by weight of a nonionic surfactant, for example from about 0.5% to about 30%, in particular from about 1% to about 20%, from about 3% to about 10%, such as from about 3% to about 5%, from about 8% to about 12%, or from about 10% to about 12%. Non-limiting examples of nonionic surfactants include alcohol ethoxylates (AE or AEO) e.g. the AEO-series such as AEO-7, alcohol propoxylates, in particular propoxylated fatty alcohols (PFA), ethoxylated and propoxylated alcohols, alkoxylated fatty acid alkyl esters, such as ethoxylated and/or propoxylated fatty acid alkyl esters (in particular methyl ester ethoxylates, MEE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

When included therein the detergent will usually contain from about 0.01 to about 10% by weight of a semipolar surfactant. Non-limiting examples of semipolar surfactants include amine oxides (AO) such as alkyldimethylamine oxides, in particular N-(coco alkyl)-N,N-dimethylamine oxide and N-(tallow-alkyl)-N,N-bis(2-hydroxyethyl)amine oxide, and combinations thereof. When included therein the detergent will usually contain from about 0.01% to about 10% by weight of a zwitterionic surfactant. Non-limiting examples of zwitterionic surfactants include betaines such as alkyldimethylbetaines, sulfobetaines, and combinations thereof.

Additional bio-based surfactants may be used e.g. wherein the surfactant is a sugar-based non-ionic surfactant which may be a hexyl-β-D-maltopyranoside, thiomaltopyranoside or a cyclic-maltopyranoside, such as described in EP2516606 B1.

Builders and Co-Builders

The detergent composition may contain about 0-65% by weight, such as about 5% to about 50% of a detergent builder or co-builder, or a mixture thereof. In a dish wash detergent, the level of builder is typically in the range 40-65%, particularly in the range 50-65%. The builder and/or co-builder may particularly be a chelating agent that forms water-soluble complexes with Ca and Mg. Any builder and/or co-builder known in the art for use in cleaning detergents may be utilized.

Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Clariant), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The detergent composition may also contain from about 0-50% by weight, such as about 5% to about 30%, of a detergent co-builder. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid (HEDP), ethylenediaminetetramethylenetetrakis(phosphonic acid) (EDTMPA), diethylenetriaminepentamethylenepentakis(phosphonic acid) (DTMPA or DTPM PA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA) , taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), aminotrimethylenetris(phosphonic acid) (ATMP), and combinations and salts thereof. Further exemplary builders and/or co-builders are described in, e.g., WO 09/102854, US 5,977,053.

Bleaching Systems

The cleaning composition may contain 0-50% by weight, such as 1-40%, such as 1-30%, such as about 1% to about 20%, of a bleaching system. Any oxygen-based bleaching system comprising components known in the art for use in cleaning detergents may be utilized. Suitable bleaching system components include sources of hydrogen peroxide; peracids and sources of peracids (bleach activators); and bleach catalysts or boosters.

Suitable sources of hydrogen peroxide are inorganic persalts, including alkali metal salts such as sodium percarbonate and sodium perborates (usually mono- or tetrahydrate), and hydrogen peroxide-urea.

Peracids may be (a) incorporated directly as preformed peracids or (b) formed in situ in the wash liquor from hydrogen peroxide and a bleach activator (perhydrolysis) or (c) formed in situ in the wash liquor from hydrogen peroxide and a perhydrolase and a suitable substrate for the latter, e.g., an ester.

Suitable preformed peracids include, but are not limited to, peroxycarboxylic acids such as peroxybenzoic acid and its ring-substituted derivatives, peroxy-a-naphthoic acid, peroxyphthalic acid, peroxylauric acid, peroxystearic acid, ε-phthalimidoperoxycaproic acid [phthalimidoperoxyhexanoic acid (PAP)], and o-carboxybenzamidoperoxycaproic acid; aliphatic and aromatic diperoxydicarboxylic acids such as diperoxydodecanedioic acid, diperoxyazelaic acid, diperoxysebacic acid, diperoxybrassylic acid, 2-decyldiperoxybutanedioic acid, and diperoxyphthalic, -isophthalic and -terephthalic acids; perimidic acids; peroxymonosulfuric acid; peroxydisulfuric acid; peroxyphosphoric acid; peroxysilicic acid; and mixtures of said compounds. It is understood that the peracids mentioned may in some cases be best added as suitable salts, such as alkali metal salts (e.g., Oxone®) or alkaline earth-metal salts.

Suitable bleach activators include those belonging to the class of esters, amides, imides, nitriles or anhydrides and, where applicable, salts thereof. Suitable examples are tetraacetylethylenediamine (TAED), sodium 4-[(3,5,5-trimethylhexanoyl)oxy]benzene-1-sulfonate (ISONOBS), sodium 4-(dodecanoyloxy)benzene-1-sulfonate (LOBS), sodium 4-(decanoyloxy)benzene-1-sulfonate, 4-(decanoyloxy)benzoic acid (DOBA), sodium 4-(nonanoyloxy)benzene-1-sulfonate (NOBS), and/or those disclosed in WO98/17767. A particular family of bleach activators of interest was disclosed in EP624154 and particularly preferred in that family is acetyl triethyl citrate (ATC). ATC or a short chain triglyceride like triacetin has the advantage that they are environmentally friendly. Furthermore, acetyl triethyl citrate and triacetin have good hydrolytical stability in the product upon storage and are efficient bleach activators. Finally, ATC is multifunctional, as the citrate released in the perhydrolysis reaction may function as a builder.

### Bleach Catalysts and Boosters

The bleaching system may also include a bleach catalyst or booster. Some non-limiting examples of bleach catalysts that may be used in the compositions of the present invention include manganese oxalate, manganese acetate, manganese-collagen, cobalt-amine catalysts and manganese triazacyclononane (MnTACN) catalysts; particularly preferred are complexes of manganese with 1,4,7-trimethyl-1,4,7-triazacyclononane (Me3-TACN) or 1,2,4,7-tetramethyl-1,4,7-triazacyclononane (Me4-TACN), in particular Me3-TACN, such as the dinuclear manganese complex [(Me3-TACN)Mn(O)3Mn(Me3-TACN)](PF6)2, and [2,2′,2″-nitrilotris(ethane-1,2-diylazanylylidene-κN-methanylylidene)triphenolato-κ3O]manganese(III). The bleach catalysts may also be other metal compounds; such as iron or cobalt complexes.

In some embodiments, where a source of a peracid is included, an organic bleach catalyst or bleach booster may be used having one of the following formulae:

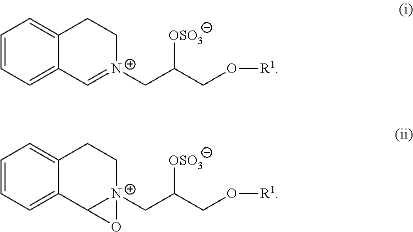

(iii) and mixtures thereof;
wherein R1 is independently a branched alkyl group containing from 9 to 24 carbons or linear alkyl group containing from 11 to 24 carbons, preferably R1 is independently a branched alkyl group containing from 9 to 18 carbons or linear alkyl group containing from 11 to 18 carbons, more preferably R1 is independently selected from the group consisting of 2-propylheptyl, 2-butyloctyl, 2-pentylnonyl, 2-hexyldecyl, dodecyl, tetradecyl, hexadecyl, octadecyl, isononyl, isodecyl, isotridecyl and isopentadecyl.

Other exemplary bleaching systems are described, e.g. in WO2007/087258, WO2007/087244, WO2007/087259, EP1867708 (Vitamin K) and WO2007/087242.

### Additional Enzymes

In addition to the present invention, enzymes may be also added to the detergent also as standard aqueous formulations or slurries—or as granulated products.

### Polymers

The detergent may contain 0.005-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(ethyleneglycol) or poly(ethylene oxide) (PEG or PEO), ethoxylated poly(ethyleneimine), (carboxymethyl)inulin (CMI), carboxylate polymers and polycarboxylates such as polyacrylates, maleic/acrylic acid copolymers, acrylate/styrene copolymers, poly(aspartic) acid, and lauryl methacrylate/acrylic acid copolymers, hydrophobically modified CMC (HM-CMC), silicones, copolymers of terephthalic acid and oligomeric glycols, copolymers of poly(ethylene terephthalate) and poly(oxyethene terephthalate) (PET-POET), poly(vinylpyrrolidone) (PVP), poly(vinylimidazole) (PVI), poly(vinylpyridine-N-oxide) (PVPO or PVPNO) and copoly(vinylimidazole/vinylpyrrolidone) (PVPVI). Suitable examples include PVP-K15, PVP-K30, ChromaBond S-400, ChromaBond S-403E and Chromabond S-100 from Ashland Aqualon, and Sokalan® HP 165, Sokalan® HP 50 (Dispersing agent), Sokalan® HP 53 (Dispersing agent), Sokalan® HP 59 (Dispersing agent), Sokalan® HP 56 (dye transfer inhibitor), Sokalan® HP 66 K (dye transfer inhibitor) from BASF.

Further exemplary polymers include sulfonated polycarboxylates, polyethylene oxide and polypropylene oxide (PEO-PPO) and diquaternium ethoxy sulfate. Particularly preferred polymer is ethoxylated homopolymer Sokalan® HP 20 from BASF, which helps to prevent redeposition of soil in the wash liqor. Further exemplary polymers include sulfonated polycarboxylates, ethylene oxide-propylene oxide copolymers (PEO-PPO), copolymers of PEG with and vinyl acetate, and diquaternium ethoxy sulfate or quaternized sulfated ethoxylated hexamethylenediamine. Other exemplary polymers are disclosed in, e.g., WO 2006/130575. Salts of the above-mentioned polymers are also contemplated.

### Adjunct Materials

Any detergent components known in the art for use in laundry/ADW/hard surface cleaning detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry/ADW/hard surface cleaning detergents may be utilized. The choice of such ingredients is well within the skill of the artisan.

### Dispersants

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Fluorescent Whitening Agent

The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2.2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

### Anti-Redeposition Agents

The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

### Rheology Modifiers

The detergent compositions of the present invention may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent , which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may also be non-aqueous.

Further embodiments of the invention include:

Embodiment 1. An enzymatic water-in-oil emulsion for use in detergents, comprising

(a) at least 50% w/w of an aqueous phase comprising at least two different detergent enzymes,
(b) an oil phase, and
(c) an emulsifier.

Embodiment 2. The emulsion of embodiment 1, wherein the aqueous phase comprises at least three different detergent enzymes.

Embodiment 3. The emulsion of embodiments 1 or 2, which comprises a protease.

Embodiment 4. The emulsion of any of embodiments 1-3, wherein one part of the aqueous phase comprises a first detergent enzyme, and another part of the aqueous phase comprises a second detergent enzyme, and the first and second detergent enzymes are not present in the same part of the aqueous phase.

Embodiment 5. The emulsion of embodiment 4, wherein the first detergent enzyme is a protease.

Embodiment 6. The emulsion of any of embodiments 1-5, wherein the aqueous phase comprises 0.1-30% w/w active enzyme protein.

Embodiment 7. The emulsion of any of embodiments 1-6, wherein the aqueous phase comprises 0.2-25% w/w active enzyme protein.

Embodiment 8. The emulsion of any of embodiments 1-7, wherein the aqueous phase comprises 0.5-20% w/w active enzyme protein.

Embodiment 9. The emulsion of any of embodiments 1-8, wherein the aqueous phase comprises 1-20% w/w active enzyme protein.

Embodiment 10. The emulsion of any of embodiments 1-9, wherein the enzyme is dissolved or dispersed in the aqueous phase.

Embodiment 11. The emulsion of any of embodiments 1-10, wherein the pH of the aqueous phase is in the range of pH 3-10.

Embodiment 12. The emulsion of any of embodiments 1-11, wherein the pH of the aqueous phase is in the range of pH 4-9.5.

Embodiment 13. The emulsion of any of embodiments 1-12, wherein the pH of the aqueous phase is in the range of pH 4.5-9.

Embodiment 14. The emulsion of any of embodiments 1-13, wherein the pH of the aqueous phase is in the range of pH 5-8.5.

Embodiment 15. The emulsion of any of embodiments 1-14, which comprises at least 55% w/w of the aqueous phase.

Embodiment 16. The emulsion of any of embodiments 1-15, which comprises at least 60% w/w of the aqueous phase.

Embodiment 17. The emulsion of any of embodiments 1-16, wherein the aqueous phase comprises a detergent enzyme selected from the group consisting of protease, lipase, cutinase, amylase, carbohydrase, cellulase, pectinase, mannanase, arabinase, galactanase, xylanase, nuclease, perhydrolase, and oxidase.

Embodiment 18. The emulsion of any of embodiments 1-17, wherein the aqueous phase comprises a detergent enzyme selected from the group consisting of protease, cutinase, amylase, carbohydrase, cellulase, pectinase, mannanase, arabinase, galactanase, xylanase, nuclease, perhydrolase, and oxidase.

Embodiment 19. The emulsion of any of embodiments 1-18, wherein the aqueous phase comprises a protease.

Embodiment 20. The emulsion of any of embodiments 1-19, wherein the aqueous phase comprises a protease and a protease inhibitor.

Embodiment 21. The emulsion of any of embodiments 1-20, wherein the aqueous phase comprises an amylase.

Embodiment 22. The emulsion of any of embodiments 1-21, wherein the aqueous phase comprises a lipase.

Embodiment 23. The emulsion of any of embodiments 1-22, wherein when the aqueous phase comprises a lipase, the emulsifier is not a glycerol ester, and the oil is not a triglyceride.

Embodiment 24. The emulsion of any of embodiments 1-23, wherein the aqueous phase has a volume average droplet size of 0.1-100 μm.

Embodiment 25. The emulsion of any of embodiments 1-24, wherein the aqueous phase has a volume average droplet size of 0.25-50 μm.

Embodiment 26. The emulsion of any of embodiments 1-25, wherein the aqueous phase has a volume average droplet size of 0.5-25 μm.

Embodiment 27. The emulsion of any of embodiments 1-26, wherein the aqueous phase has a volume average droplet size of 1-10 μm.

Embodiment 28. The emulsion of any of embodiments 1-27, wherein the oil phase comprises an oil-soluble detergent ingredient, such as a perfume.

Embodiment 29. A method for preparing an enzymatic detergent, comprising mixing the enzymatic water-in-oil emulsion of any of embodiments 1-28, and a detergent or a premix thereof.

Embodiment 30. The method of embodiment 29, wherein the detergent is a liquid detergent.

Embodiment 31. The method of embodiment 29 or 30, wherein the detergent comprises a surfactant and/or a detergent builder.

Embodiment 32. The method of any of embodiments 29-31, wherein the detergent is a laundry or dish wash detergent.

Embodiment 33. A method for preparing the enzymatic water-in-oil emulsion of any of embodiments 1-28, comprising mixing two enzymatic water-in-oil emulsions, each comprising

(a) at least 50% w/w of an aqueous phase comprising at least one detergent enzyme,
(b) an oil phase, and
(c) an emulsifier;
wherein the two enzymatic water-in-oil emulsions comprises different detergent enzymes.

Embodiment 34. The method of embodiment 33, wherein one of the emulsions contain only a protease.

The present invention is further described by the following examples which should not be construed as limiting the scope of the invention.

### EXAMPLES

Chemicals were commercial products of at least reagent grade. The protease was subtilisin 309 (Savinase). The lipasel was a variant of Thermomyces lanuginosus lipase, and the lipase2 was a (different) variant of Thermomyces lanuginosus lipase. The nature of the specific enzymes is not important. The lipases were included because they are sensitive towards proteases. The aqueous phases of the examples contained approx. 1-10% w/w of active enzyme protein, 10-60% w/w of polyols (such as MPG, glycerol, sorbitol), and minors like calcium and preservatives.

### Example 1

Effect of % Oil in Emulsion on General Detergency

Lard swatches were prepared by applying 100 microliter melted lard onto 5×5 cm prewashed cotton swatches (dried 15 minutes at 100° C.), and subsequently cooling the swatches.

### Liquid Detergent A

Detergent A was prepared with the following components (% w/w):

| | |
|---|---|
| 12.0% | linear alkylbenzene sulfonic acid (LAS-acid) |
| 9.5% | alcohol ethoxylate (C13, 7-8EO) |
| 5.5% | soy fatty acid |
| 4.5% | coco fatty acid |
| 5.0% | mono propylene glycol (MPG) |
| 4.6% | ethanol |
| 2.0% | triethanolamine (TEA) |
| 3.0% | NaOH |
| 1.0% | phosphonate (Dequest 2066) |
| 1.0% | Na-citrate dihydrate |
| 0.5% | phenoxyethanol |

Water ad 100%
pH 8.2

Detergent A was used at 1.8 g/liter in a Terg-O-Tometer™ (TOM) laboratory washing machine (1 liter washes). The water hardness was set to 15° dH (CaCl₂:MgCl₂:NaHCO₃ 4:1:7.5), and the washing conditions were 20° C. for 20 minutes using 120 rpm, followed by rinsing the lard swatches in cold water and drying for 20 minutes at 100° C. Two lard swatches (plus “ballast” cotton swatches without lard up to 30 g in total) was used in each wash. Dry lard swatches were weighed before and after wash, and the weight loss determines the percent lard removed (using the average weight losses from the two swatches). The higher percent the better wash.
To illustrate the effect on general detergency by adding a water-in-oil emulsion, a mixture of water (as placebo aqueous/enzyme phase) and oil was added to the detergent, and the effect on wash performance was tested. Two types of oils were tested, Whiteway 15 (from Statoil) and Isopar M (from ExxonMobil). The placebo enzyme emulsion was dosed as 0.5% w/w of the detergent.

TABLE 1
Wash results (dosages per 1 liter wash liqor):

| | | | | | % oil in | % lard |
|---|---|---|---|---|---|---|
| # | Oil | Detergent | Water | Oil | ‘emulsion’ | removed |
| I | no oil | 1.8 g | 0.0 mg | 0.0 mg | 0% | 50.5 |
| II | Whiteway 15 | 1.8 g | 9.0 mg | 10.0 mg | 53% | 48.0 |
| III | Whiteway 15 | 1.8 g | 9.0 mg | 20.0 mg | 69% | 43.9 |
| IV | Whiteway 15 | 1.8 g | 9.0 mg | 80.0 mg | 90% | 28.8 |
| V | Isopar M | 1.8 g | 9.0 mg | 10.0 mg | 53% | 46.8 |
| VI | Isopar M | 1.8 g | 9.0 mg | 20.0 mg | 69% | 41.8 |
| VII | Isopar M | 1.8 g | 9.0 mg | 80.0 mg | 90% | 21.8 |

It is clear that oil has a significant negative influence on the removal of lard from the swatches. The data in Table 1 also show that emulsions comprising less than 50% oil (at least 50% aqueous phase) are expected to have only a minor negative influence on the removal of lard (detergency).

### EXAMPLE 2

Preparation of Enzymatic Emulsion

Three enzymatic emulsion were produced, A (lipase2), B (protease), C (lipase2+protease). All three emulsions were water-in-oil emulsions containing 78% w/w water phase and 22% w/w oil phase. The emulsions contained 4% w/w emulsifier (ABIL EM90, Evonik), and mineral oil (Whiteway 2, Statoil) as the continuous phase.

TABLE 2
Emulsions A, B and C.

| | | | | Aqueous | Aqueous |
|---|---|---|---|---|---|
| | | | | phase | phase |
| # | Description | Oil | Emulsifier | (protease) | (lipase2) |
| A | Lipase in aqueous | 36 g | 8 g | 0 g | 156 g |
| | phase | | | | |
| B | Protease in | 36 g | 8 g | 156 g | 0 g |
| | aqueous phase | | | | |

| | | |
|---|---|---|
| C | Lipase and | Emulsion C was a 1:1 mixture |
| | protease in | of emulsions A and B |
| | separate aqueous | |
| | phases | |

Emulsions A and B were prepared separately in two 250 mL glass beakers fitted with baffles at room temperature. The oil and emulsifier were added to each glass beaker and mixed by stirring thoroughly by stirring with a 4 winged 30 mm impeller at 500 rpm. The water phases (containing the enzymes) were added slowly over approx. 20 seconds, and subsequently the stirring speed was increased to 2000 rpm. The two emulsions were finalized by stirring for 30 minutes.
Emulsion C was prepared by manual mixing of 80 g of each of emulsions A and B in a beaker glass. The resulting blend of emulsions (emulsion C) appeared homogenous with similar viscosity and other properties as emulsions A and B.

### EXAMPLE 3

Addition of Enzymatic Emulsion to Liquid Detergent

Detergent B was prepared with the following components (% w/w):

| | |
|---|---|
| 11.6% | Linear alkylbenzene sulfonic acid (LAS) |
| 11.0% | Alcohol ethoxylate (8EO) |
| 6.0% | mono propylene glycol (MPG) |
| 4.9% | Sodium lauryl ether sulfate (SLES) |
| 3.3% | Triethanolamine (TEA) |
| 2.8% | Soy fatty acid |
| 2.8% | Coco fatty acid |
| 2.7% | Ethanol |
| 2.0% | Na-citrate dihydrate |
| 1.8% | NaOH |
| 1.7% | Glycerol |
| 1.0% | Na-formate |
| 0.3% | Propan-2-ol |
| 0.2% | Phosphonate (Dequest 2066) |
| 0.2% | Co-poly(acrylic acid/maleic acid), |
| | sodium salt (Sokalan CP-5) |

Water ad 100%

An enzymatic liquid detergent was produced by mixing 49.5 g of Detergent B with 0.5 g (1% w/w) of emulsion C from Example 2. The mixing was carried out for one minute at 800 rpm at room temperature. The emulsion was completely mixed into the detergent after less than 20 seconds. The physical appearance of the resulting enzymatic liquid detergent was identical to Detergent B.

The experimental results show that individual enzymatic water-in-oil emulsions could be easily mixed with one another to yield a homogenous blend of emulsions. This blend of enzyme emulsions had no negative impact on the physical properties of a liquid detergent, at the dosage used in the experiment.

### EXAMPLE 4

Stabilization of Lipase Against Proteolytic Degradation

Four enzymatic emulsion were produced, A (lipasel), B (protease), C (lipasel+protease in same aqueous phase), and D (lipase1+protease in two separate aqueous phases). All four emulsions were water-in-oil emulsions containing 60% w/w water phase and 40% w/w oil phase. The oil phase contained 9% w/w emulsifier (20% high-MW hydrolyzed copolymer of styrene, stearyl methacrylate and maleic anhydride terpolymer in paraffinic oil), and 91% w/w mineral oil (Whiteway 15, Statoil) as the continuous phase.

TABLE 3
Emulsions A, B, C, and D.

| | | Oil phase | Aqueous | Aqueous |
|---|---|---|---|---|
| | | (oil + | phase | phase |
| # | Description | emulsifier) | (protease) | (lipase1) |
| A | Lipase in aqueous | 40 g | 0 g | 60 g |
| | phase | | | |
| B | Protease in aqueous | 40 g | 60 g | 0 g |
| | phase | | | |
| C | Lipase and protease | 40 g | 30 g | 30 g |
| | in same aqueous | | | |
| | phase | | | |

| | | |
|---|---|---|
| D | Lipase and protease | Emulsion D was a 1:1 mixture |
| | in two separate | of emulsions A and B |
| | aqueous phases | |

Emulsions A, B, and C were prepared separately in three 250 mL glass beakers fitted with baffles at room temperature. The oil and emulsifier were added to each glass beaker and mixed thoroughly by stirring with a 4 winged 30 mm impeller at 500 rpm. The water phases (containing the enzymes) were added slowly over approx. 20 seconds, and subsequently the stirring speed was increased to 1800 rpm. The three emulsions were finalized by stirring for 10 minutes.

Emulsion D was prepared by manual mixing of emulsions A and B in a separate beaker glass at 1000 rpm for 15 minutes. The resulting blend of emulsions (emulsion D) appeared homogenous and with similar properties as emulsions A and B.

### Residual Lipase Activity After Storage

Samples of Emulsions C and D were stored at -18° C., 5° C., 25° C., and 45° C. for 3 weeks. The samples stored at −18° C. were used as reference samples (defined as 100% residual activity).

TABLE 4
Residual lipase1 activity after storage at 5° C.,
25° C., and 45° C. for 3 weeks.

| | Residual lipase activity | |
|---|---|---|
| Temperature | Emulsion C | Emulsion D |
| 5° C. | 103% | 106% |
| 25° C. | 68% | 98% |
| 45° C. | 1% | 78% |

The data in Table 4 show that lipase stability is poor when mixed with protease in the same water phase. However, when the lipase and protease are stored in separate water phases (emulsion droplets), the lipase stability is excellent.

### EXAMPLE 5

Stability of Enzymatic Emulsions Using Different Emulsifiers

Many different water-in-oil emulsifiers, often well-known, were tested in the laboratory. Three enzyme concentrates (Novozymes) were used in the water phase and two different oils (Whiteway 2 and Whiteway 15 mineral oil, Statoil) were used in the oil phase. All emulsions were prepared with water phases made of one enzyme concentrate, with one exception (emulsion #14). The effects of a well-known stabilizing salt (magnesium sulfate, heptahydrate) was also examined.

TABLE 5
Emulsifiers used in the example.

| Emulsifier | Chemistry | Supplier |
|---|---|---|
| ASI | High-MW hydrolyzed copolymer of | Ashland |
| | styrene, stearyl methacrylate and | |
| | maleic anhydride terpolymer | |
| Cithrol DPHS | PEG-30 dipolyhydroxystearate | Croda |
| ISOLAN GPS | Polyglyceryl-4 Diisostearate/ | Evonik |
| | Polyhydroxystearate/Sebacate | |
| ISOLAN PDI | Diisostearoyl Polyglyceryl-3 | Evonik |
| | Dimer Dilinoleate | |
| ISOLAN 17 S | Polyglyceryl-4 Diisostearate/ | Evonik |
| | Polyhydroxystearate/Sebacate; | |
| | Caprylic/Capric Triglyceride; | |
| | Polyglyceryl-3 Oleate; Diisostearoyl | |
| | Polyglyceryl-3 Dimer Dilinoleate | |
| ABIL EM90 | Cetyl PEG/PPG-10/1 Dimethicone | Evonik |
| ABIL EM180 | Cetyl PEG/PPG-10/1 Dimethicone | Evonik |
| Plurol | Polyglyceryl-3 Diisostearate | Gattefossé |
| Diisostéarique | | |
| Berol 050 | C_{12/14} fatty alcohol, 3EO | Nouryon |
| Marlox RT42 | Linear C₁₆₋₁₈, ethoxylated propoxylated | Sasol |
| Marlox RT64 | Linear C₁₆₋₁₈, ethoxylated propoxylated | Sasol |
| Brij 93 | Polyoxyethylene Oleyl Ether | Sigma |
| | | Aldrich |

### Manufacture of Enzyme Emulsions

The emulsions were prepared separately in 250 mL glass beakers fitted with baffles at room temperature. The oil and emulsifier (oil phase) were added to each glass beaker and mixed by stirring thoroughly by stirring with a 4 winged 30 mm impeller at 500 rpm. The water phases (containing the enzymes) were added slowly over approx. 20 seconds, and subsequently the stirring speed was increased to 2000 rpm. The enzymatic emulsions were finalized by stirring for 30 minutes. Table 6 shows an overview of the emulsions. The emulsions were stored for at least one month at room temperature.

TABLE 6
Enzymatic emulsions.

| # | Oil Phase | Aqueous phase | Enzyme(s) | Stable ? |
|---|---|---|---|---|
| 1 | 34 g Whiteway 15 | 65 g | Protease | Yes |
| | 1 g ASI | | | |
| 2 | 38 g Whiteway 2 | 160 g | Lipase2 | Yes |
| | 2 g ASI | | | |
| 3 | 27.5 g Whiteway 15 | 120 g | Protease | Yes |
| | 1.5 g Cithrol DPHS | | | |
| 4 | 29 g Whiteway 15 | 70 g | Protease | Yes |
| | 1 g Cithrol DPHS | | | |
| 5 | 12.8 g Whiteway 15 | 144 g incl. 2.4 g | Protease | Yes |
| | 3.2 g Cithrol DPHS | MgSO₄•₇H₂0 | | |
| 6 | 26 g Whiteway 2 | 170 g | Protease | Yes |
| | 3 g Cithrol DPHS | | | |
| | 1 g ASI | | | |
| 7 | 28.8 g Whiteway 15 | 128 g | Protease | Yes |
| | 3.2 g ISOLAN GPS | | | |
| 8 | 34.35 g Whiteway 15 | 128 g | Protease | Yes |
| | 0.65 g ISOLAN PDI | | | |
| 9 | 36.8 g Whiteway 15 | 120 g | Protease | Yes |
| | 2.4 g ISOLAN GPS | | | |
| | 0.8 g ISOLAN PDI | | | |
| 10 | 36.8 g Whiteway 15 | 120 g incl. 2.4 g | Protease | Yes |
| | 2.4 g ISOLAN GPS | MgSO₄•₇H₂0 | | |
| | 0.8 g ISOLAN PDI | | | |
| 11 | 36 g Whiteway 2 | 160 g | Protease | Yes |
| | 4 g ISOLAN 17 S | | | |
| 12 | 36 g Whiteway 2 | 160 g | Protease | Yes |
| | 4 g ABIL EM90 | | | |
| 13 | 46 g Whiteway 2 | 150 g | Lipase2 | Yes |
| | 4 g ABIL EM90 | | | |
| 14 | 36 g Whiteway 2 | 156 g | Protease & | Yes |
| | 8 g ABIL EM90 | | Lipase2 | |
| | | | (1:1 mixture) | |
| 15 | 48 g Whiteway 2 | 150 g | Protease | Yes |
| | 2 g ABIL EM180 | | | |
| 16 | 49 g Whiteway 15 | 160 g | Lipase2 | Yes |
| | 1 g ABIL EM180 | | | |
| 17 | 36 g Whiteway 2 | 160 g | Protease | Yes |
| | 4 g Plurol | | | |
| | Diisostéarique | | | |
| 18 | 36 g Whiteway 2 | 160 g | Protease | Yes |
| | 4 g Berol 050 | | | |
| 19 | 36 g Whiteway 2 | 160 g | Protease | Yes |
| | 4 g Berol 050 | | | |
| 20 | 36 g Whiteway 2 | 160 g | Protease | Yes |
| | 4 g Marlox RT42 | | | |
| 21 | 35 g Whiteway 2 | 160 g | Protease | Yes |
| | 4 g Marlox RT42 | | | |
| | 1 g ASI | | | |
| 22 | 36 g Whiteway 2 | 160 g | Lipase2 | Yes |
| | 4 g Marlox RT64 | | | |
| 23 | 35 g Whiteway 2 | 160 g | Lipase2 | Yes |
| | 4 g Marlox RT64 | | | |
| | 1 g ASI | | | |
| 24 | 35.5 g Whiteway 2 | 160 g | Lipase1 | Yes |
| | 4 g Brij 93 | | | |
| | 0.5 g ASI | | | |

### Conclusions

Many emulsifiers allow for the preparation of stable emulsions of enzymes, either alone or in combination with another emulsifier and/or emulsion-stabilizing salt.

### EXAMPLE 6

Stabilization of Lipase Against Proteolytic Degradation

Four enzymatic emulsion were produced, A (protease), B (lipase2), C (lipase2+protease in same aqueous phase), and D (lipase2+protease in two separate aqueous phases). All four emulsions were water-in-oil emulsions containing 78% w/w water phase and 22% w/w oil phase. The oil phases were prepared with ABIL® EM180 (Evonik) as emulsifier, and mineral oil (Whiteway 2, Statoil) as continuous phase. The end concentration of the emulsifier in the emulsions was 4% w/w.

TABLE 7
Emulsions A, B, C, and D.

| | | Oil phase | Aqueous | Aqueous |
|---|---|---|---|---|
| | | (oil + | phase | phase |
| # | Description | emulsifier) | (protease) | (lipase2) |
| A | Protease in aqueous | 44 g | 156 g | 0 g |
| | phase | | | |
| B | Lipase2 in aqueous | 44 g | 0 g | 156 g |
| | phase | | | |
| C | Lipase2 and | 44 g | 78 g | 78 g |
| | protease in same | | | |
| | aqueous phase | | | |

| | | |
|---|---|---|
| D | Lipase and protease | Emulsion D was a 1:1 mixture of |
| | in two separate | emulsions A and B |
| | aqueous phases | |

Emulsions A, B, and C were prepared separately in three 250 mL glass beakers fitted with baffles at room temperature. The oil and emulsifier were added to each glass beaker and mixed thoroughly by stirring with a 4 winged 30 mm impeller at 500 rpm. The water phases (containing the enzymes) were added slowly over approx. 20 seconds, and subsequently the stirring speed was increased to 2000 rpm. The three emulsions were finalized by stirring for 30 minutes. Emulsion D was prepared by manual mixing of emulsions A and B in a separate beaker glass at 1000 rpm for 15 minutes. The resulting blend of emulsions (emulsion D) appeared homogenous and with similar properties as emulsions A and B.
Residual lipase activity after storage
Samples of emulsions B, C and D were stored at −18° C. and 40° C. for 4 weeks. The samples stored at -18° C. were used as reference samples (defined as 100% residual activity).

TABLE 8
Residual lipase2 activity after storage at 40° C. for 4 weeks.
Residual lipase activity

| Emulsion B | Emulsion C | Emulsion D |
|---|---|---|
| 100% | 75% | 106% |

The data in Table 8 show that lipase stability is poor when mixed with protease in the same water phase. However, when the lipase and protease are stored in separate water phases (emulsion droplets), the lipase stability is excellent.

1-15. (canceled)

16. An enzymatic water-in-oil emulsion, comprising:
(a) at least 50% w/w of an aqueous phase comprising at least two different detergent enzymes;
(b) an oil phase; and
(c) an emulsifier;
wherein one part of the aqueous phase comprises a first detergent enzyme, and another part of the aqueous phase comprises a second detergent enzyme, and wherein the first and second detergent enzymes are not present in the same part of the aqueous phase.

17. The emulsion of claim 16, wherein the aqueous phase comprises 0.1-30% w/w active enzyme protein.

18. The emulsion of claim 16, wherein the aqueous phase has a volume average droplet size of 0.1-100 μm.

19. The emulsion of claim 16, wherein the enzyme is dissolved or dispersed in the aqueous phase.

20. The emulsion of claim 16, wherein the pH of the aqueous phase is in the range of pH 3-10.

21. The emulsion of claim 16, wherein the detergent enzyme is selected from the group consisting of protease, lipase, cutinase, amylase, carbohydrase, cellulase, pectinase, mannanase, arabinase, galactanase, xylanase, nuclease, perhydrolase, and oxidase.

22. The emulsion of claim 16, wherein the aqueous phase further comprises a polyol.

23. The emulsion of any of claim 16, wherein the aqueous phase has a pH in range of pH 4-9.

24. The emulsion of claim 16, which comprises at least 60% w/w of the aqueous phase.

25. An enzymatic water-in-oil emulsion, comprising:
(a) at least 50% w/w of an aqueous phase comprising at least two different detergent enzymes;
(b) an oil phase; and
(c) an emulsifier;
wherein the aqueous phase comprises 0.1-30% w/w active enzyme protein.

26. The emulsion of claim 25, wherein the aqueous phase has a volume average droplet size of 0.1-100 μm.

27. The emulsion of claim 25, wherein the enzyme is dissolved or dispersed in the aqueous phase.

28. The emulsion of claim 25, wherein the pH of the aqueous phase is in the range of pH 3-10.

29. The emulsion of claim 25, wherein the detergent enzyme is selected from the group consisting of protease, lipase, cutinase, amylase, carbohydrase, cellulase, pectinase, mannanase, arabinase, galactanase, xylanase, nuclease, perhydrolase, and oxidase.

30. The emulsion of claim 25, wherein the aqueous phase further comprises a polyol.

31. The emulsion of claim 25, wherein the aqueous phase has a pH in range of pH 4-9.

32. The emulsion of claim 25, which comprises at least 60% w/w of the aqueous phase.

33. A method for preparing an enzymatic detergent, the method comprising mixing the enzymatic water-in-oil emulsion of claim 16, and a detergent or a premix thereof.

34. The method of claim 33, wherein the detergent is a liquid laundry or dish wash detergent.

35. A method for preparing the enzymatic water-in-oil emulsion of claim 16, the method comprising: mixing two enzymatic water-in-oil emulsions, each comprising:
(a) at least 50% w/w of an aqueous phase comprising at least one detergent enzyme;
(b) an oil phase; and
(c) an emulsifier;
wherein the two enzymatic water-in-oil emulsions comprises different detergent enzymes.

36. The method of claim 35, wherein the enzymatic water-in-oil emulsions comprises at least 60% w/w of the aqueous phase.
